(19) United States
(12) Patent Application Publication
(10) Pub. No.: US 2023/0376449 A1
(43) Pub. Date: Nov. 23, 2023

(54) SIGNAL PROCESSING DEVICE

(71) Applicant: Sony Semiconductor Solutions Corporation, Kanagawa (JP)

(72) Inventor: Taichi Hirao, Tokyo (JP)

(21) Appl. No.: 18/248,180

(22) PCT Filed: Nov. 10, 2021
(86) PCT No.: PCT/JP2021/041273

§ 371 Date: Apr. 6, 2023

(30) Foreign Application Priority Data
Nov. 24, 2020 (JP) 2020-194270

(51) Int. Cl. G06F 15/82; G06F 9/38

(52) U.S. Cl. CPC G06F 15/82; G06F 9/3867

(57) ABSTRACT

The present disclosure relates to a signal processing device that enables easier control of pipeline processing.

There are included a plurality of processing units that performs respective signal processes on an input signal in series, a parameter supply unit that supplies a parameter used for the signal processes to the plurality of processing units, and a control unit that controls an execution timing of the signal process by each of the plurality of processing units and a supply timing of the parameter by the parameter supply unit on the basis of a synchronization signal in such a manner that pipeline processing is performed on the input signal. The present disclosure can be applied to, for example, a signal processing device, an electronic device, a signal processing method, a program, or the like.

### TECHNICAL FIELD

The present disclosure relates to a signal processing device, and more particularly relates to a signal processing device capable of further facilitating control of pipeline processing.

### BACKGROUND ART

Conventionally, in a signal processing pipeline, when each module in a signal processing block processes frame data flowing from a sensor, each module starts operation with a vertical synchronization signal as a trigger. Furthermore, there is a system architecture construction technology in high-level synthesis including a start control/end control signal (see, for example, Patent Document 1).

### CITATION LIST

### Non Patent Document

Patent Document 1: Japanese Translation of PCT International Application Publication No. 2017-518577

### SUMMARY OF THE INVENTION

### Problems to be Solved by the Invention

However, in the conventional signal processing pipeline method, it has been difficult to control the activation timing of each signal processing module and the timing of setting a parameter for each signal processing module. Furthermore, also in the technology described in Patent Document 1, one data flow is assumed, and a flow of other data (parameters) is not considered.

The present disclosure has been made in view of such a situation, and makes it possible to further facilitate control of pipeline processing.

### Solutions to Problems

A signal processing device according to one aspect of the present technology is a signal processing device including a plurality of processing units that performs respective signal processes on an input signal in series, a parameter supply unit that supplies a parameter used for the signal processes to the plurality of processing units, and a control unit that controls an execution timing of the signal process by each of the plurality of processing units and a supply timing of the parameter by the parameter supply unit on the basis of a synchronization signal in such a manner that pipeline processing is performed on the input signal.

The signal processing device according to one aspect of the present technology includes a plurality of processing units that performs respective signal processes on an input signal in series, a parameter supply unit that supplies a parameter used for the signal processes to the plurality of processing units, and a control unit that controls an execution timing of the signal process by each of the plurality of processing units and a supply timing of the parameter by the parameter supply unit on the basis of a synchronization signal in such a manner that pipeline processing is performed on the input signal.

### BRIEF DESCRIPTION OF DRAWINGS

FIG. 1 is a block diagram illustrating a configuration example of a signal processing device.

FIG. 2 is a block diagram illustrating a configuration example of the signal processing device.

FIG. 3 is a diagram describing a configuration of control signals.

FIG. 4 is a diagram illustrating an example of a timing chart of the control signals.

FIG. 5 is a flowchart illustrating an example of a flow of control processing.

FIG. 6 is a block diagram illustrating a configuration example of the signal processing device.

FIG. 7 is a diagram describing a configuration of control signals.

FIG. 8 is a diagram illustrating an example of a timing chart of the control signals.

FIG. 9 is a flowchart illustrating an example of a flow of software reset processing.

FIG. 10 is a block diagram illustrating a configuration example of the signal processing device.

FIG. 11 is a diagram illustrating an example of a timing chart of pipeline processing.

FIG. 12 is a flowchart illustrating an example of a flow of control processing.

FIG. 13 is a block diagram illustrating a configuration example of the signal processing device.

FIG. 14 is a block diagram illustrating a configuration example of a parameter selection unit.

FIG. 15 is a diagram describing an example of a state of parameter selection.

FIG. 16 is a flowchart illustrating an example of a flow of control processing.

FIG. 17 is a block diagram illustrating a configuration example of the signal processing device.

FIG. 18 is a flowchart illustrating an example of a flow of control processing.

FIG. 19 is a block diagram illustrating a configuration example of the signal processing device.

FIG. 20 is a flowchart illustrating an example of a flow of control processing.

FIG. 21 is a block diagram illustrating a configuration example of the signal processing device.

FIG. 22 is a block diagram illustrating a configuration example of the signal processing device.

FIG. 23 is a block diagram illustrating a configuration example of the signal processing device.

FIG. 24 is a block diagram illustrating a configuration example of the signal processing device.

FIG. 25 is a block diagram illustrating a main configuration example of a computer.

### MODE FOR CARRYING OUT THE INVENTION

Hereinafter, modes for carrying out the present disclosure (hereinafter referred to as embodiments) will be described. Note that the description will be made in the following order.
1. First embodiment (signal processing device)
2. Second embodiment (signal processing device)
3. Third embodiment (signal processing device)
4. Fourth embodiment (signal processing device)
5. Fifth embodiment (signal processing device)
6. Sixth embodiment (signal processing device)
7. Seventh embodiment (signal processing device)
8. Eighth embodiment (signal processing device)
9. Ninth embodiment (signal processing device)
10. Tenth embodiment (signal processing device)
11. Eleventh embodiment (signal processing device)
12. Appendix

### 1. FIRST EMBODIMENT

<Pipeline Processing>

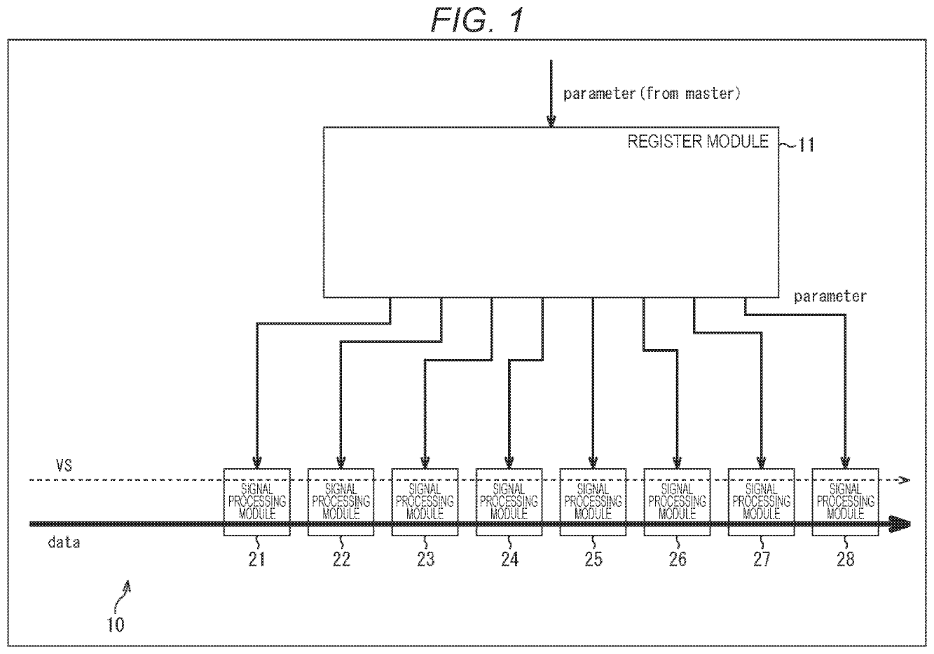

Conventionally, there has been a signal processing device in which a plurality of signal processing modules sequentially performs respective signal processes on an input signal in series. Such signal processing is also referred to as pipeline processing. A signal processing device 10 illustrated in FIG. 1 is a conventional device that performs such pipeline processing on an input signal (data). That is, the signal processing device 10 includes signal processing modules 21 to 28 that perform respective predetermined signal processes. As indicated by thick arrows in FIG. 1, the signal processing modules 21 to 28 are arranged in series with the input signal (data) and perform the respective signal processes in this order. That is, the signal processing modules 21 to 28 perform the pipeline processing on the input signal (data).

Moreover, the signal processing device 10 further includes a register module 11. The register module 11 holds a parameter supplied from a master and supplies the parameter to the signal processing modules 21 to 28 at a predetermined timing. The signal processing modules 21 to 28 perform the respective signal processes using the parameters supplied from the register module 11. That is, the register module 11 supplies a parameter used for pipeline processing to each signal processing module.

In such a conventional signal processing device 10, a synchronization signal is supplied to the signal processing modules 21 to 28 as indicated by dotted arrows in FIG. 1. For example, in a case of image processing or the like, a vertical synchronization signal (VS) is supplied to the signal processing modules 21 to 28. Each of the signal processing modules 21 to 28 has started operation with such a synchronization signal (vertical synchronization signal) as a trigger.

However, in such a method, it has been difficult to control the activation timing of each signal processing module and the timing of setting a parameter for each signal processing module. For example, in a case where the parameter is dynamically changed, it is necessary to change the parameter at an appropriate timing with respect to the progress of the pipeline processing in order to appropriately perform the pipeline processing. However, in the conventional method, the direction in which the data frame flows and the direction in which the parameter is set are different from each other. Moreover, since each of the signal processing modules operates in accordance with the synchronization signal as described above, it has been difficult to grasp the state of each signal processing module in a case where a plurality of frames is simultaneously processed as the entire signal processing block. Thus, it has been difficult to change the parameter at an appropriate timing for the progress of the pipeline processing as described above.

<Signal Processing Device>

Therefore, a control unit that controls an operation timing of each signal processing module and a change timing of the parameter of the register module on the basis of the synchronization signal is provided. A V synchronization signal (Vsync/VS) indicating a starting point of frame data arriving in pairs with the frame data is once separated from the frame data in the signal processing block and given to a control block, and an activation signal is generated in the control block and each module in the signal processing block is controlled, to thereby collectively perform management of each module, and also make a parameter setting path and an activation path the same.

For example, a signal processing device includes a plurality of processing units that performs respective signal processes on an input signal in series, a parameter supply unit that supplies a parameter used for the signal processes to the plurality of processing units, and a control unit that controls an execution timing of the signal process by each of the plurality of processing units and a supply timing of the parameter by the parameter supply unit on the basis of a synchronization signal in such a manner that pipeline processing is performed on the input signal.

By controlling the timing of each process, the control unit can more easily change the parameter at an appropriate timing with respect to the progress of the pipeline processing.

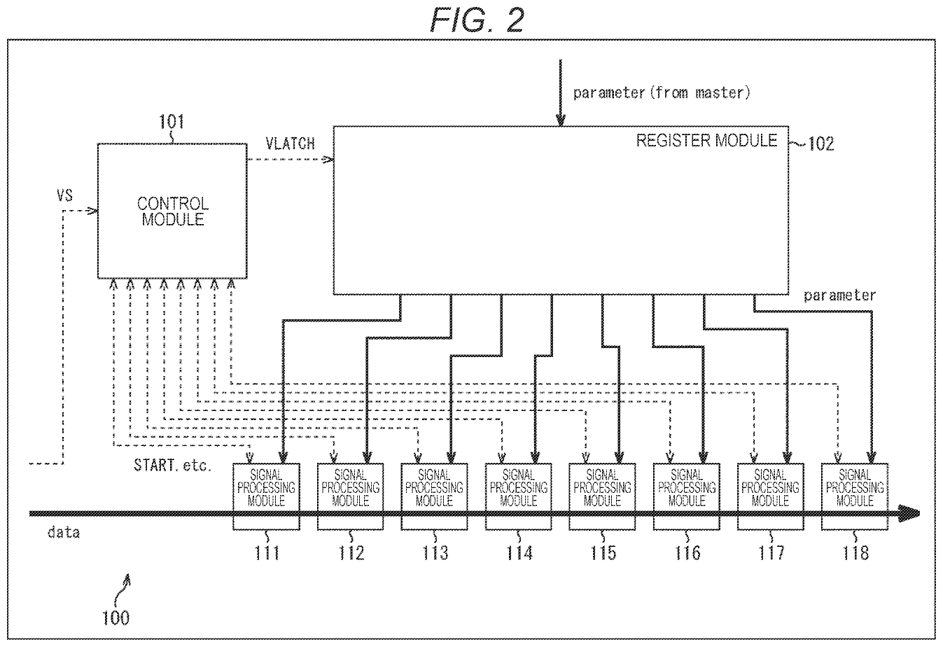

FIG. 2 is a block diagram illustrating an example of a main configuration of one aspect of a signal processing device to which the present technology is applied. A signal processing device 100 illustrated in FIG. 2 is a device that performs the pipeline processing on the input signal (data).

As illustrated in FIG. 2, the signal processing device 100 includes a control module 101, a register module 102, and signal processing modules 111 to 118.

As indicated by thick arrows in FIG. 2, the signal processing modules 111 to 118 are arranged in series with the input signal (data) and perform the respective signal processes in this order. That is, the signal processing modules 111 to 118 perform the pipeline processing on the input signal (data) (perform the respective signal processes in series).

The register module 102 holds the parameter supplied from the master and supplies the parameter to the signal processing modules 111 to 118 at a predetermined timing. The signal processing modules 111 to 118 perform the respective signal processes using the parameters supplied from the register module 102. That is, the register module 102 is a parameter supply unit that supplies a parameter used for pipeline processing to each signal processing module.

The control module 101 is a control unit that controls a supply timing of the parameter by the register module 102 and operation timings of the signal processing modules 111 to 118. The control module 101 controls the execution timing of the signal process by each of the signal processing modules 111 to 118 and the supply timing of the parameter by the register module 102 on the basis of the synchronization signal in such a manner that the pipeline processing on the input signal (data) is implemented.

<Control Signal>

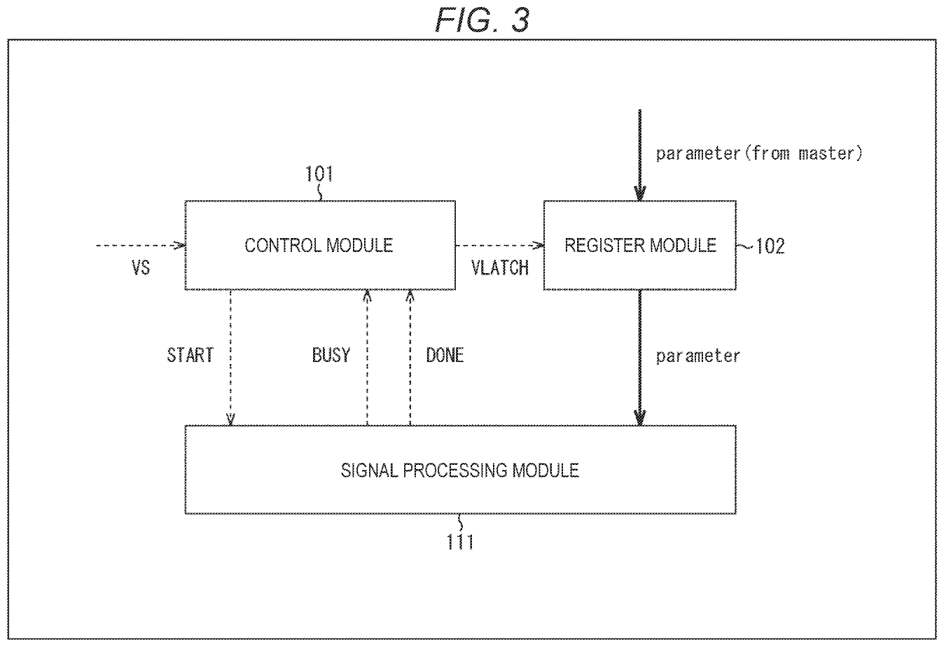

The control signal will be described with reference to FIG. 3. Note that FIG. 3 illustrates only the signal processing module 111 among the signal processing modules 111 to 118. Although only the signal processing module 111 will be described here, the other signal processing modules 112 to 118 are configured similarly to the signal processing module 111. That is, the description of the signal processing module 111 can also be applied to the other signal processing modules 112 to 118.

As indicated by dotted arrows in FIG. 3, the control module 101 receives the vertical synchronization signal (VS) as input. Furthermore, the control module 101 supplies a control signal VLATCH to the register module 102. The control signal VLATCH is a control signal giving an instruction on a timing of switching a parameter. The control module 101 supplies (switches on and off) the control signal VLATCH at a timing synchronized with the vertical synchronization signal (VS). The register module 102 changes the parameter to be supplied to the signal processing module at the timing based on the control signal VLATCH.

Furthermore, the control module 101 supplies a control signal START to the signal processing module 111. The control signal START is a control signal giving an instruction to start a signal process. The control module 101 supplies (switches on and off) the control signal START at a timing synchronized with the vertical synchronization signal (VS). The signal processing module 111 starts an operation of the signal process at the timing based on the control signal START.

Furthermore, the signal processing module 111 supplies a control signal BUSY and a control signal DONE to the control module 101. The control signal BUSY is a control signal indicating that an operation is being performed. The control signal DONE is a control signal indicating that an operation is completed. The control module 101 can easily grasp the operating state of the signal processing module 111 on the basis of these control signals.

The control module 101 supplies the control signal VLATCH on the basis of these control signals. Therefore, the register module 102 can change the parameter at an appropriate timing with respect to the progress of the pipeline processing. That is, the pipeline processing can be more easily controlled.

<Flow of Control Processing>

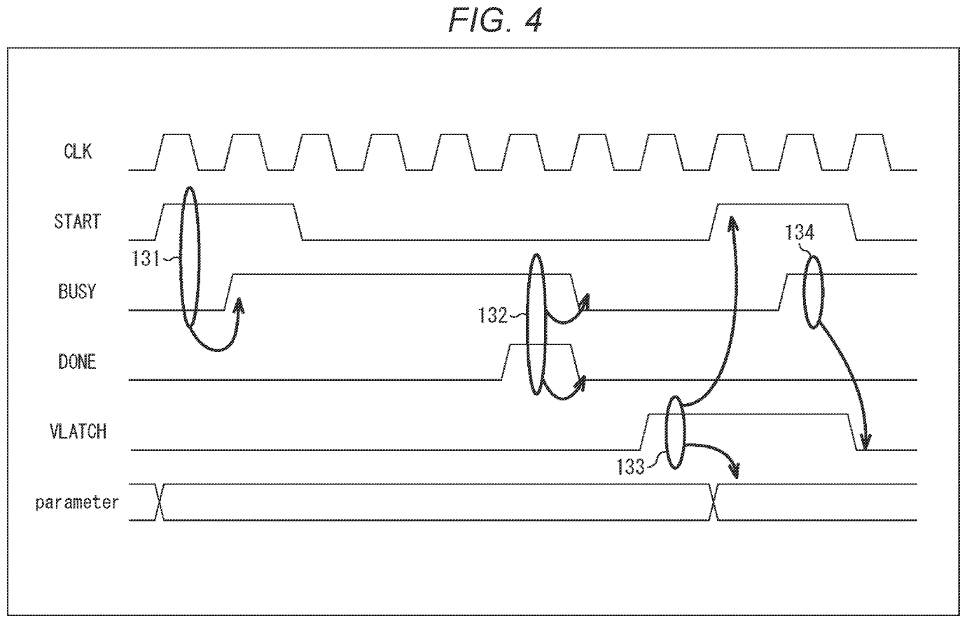

An example of a timing chart of these control signals is illustrated in FIG. 4. In FIG. 4, a signal CLK is a clock signal and is synchronized with the vertical synchronization signal (VS) of FIG. 3. The control signal START, the control signal BUSY, the control signal DONE, and the control signal VLATCH are supplied (turned on and off) as illustrated in FIG. 4.

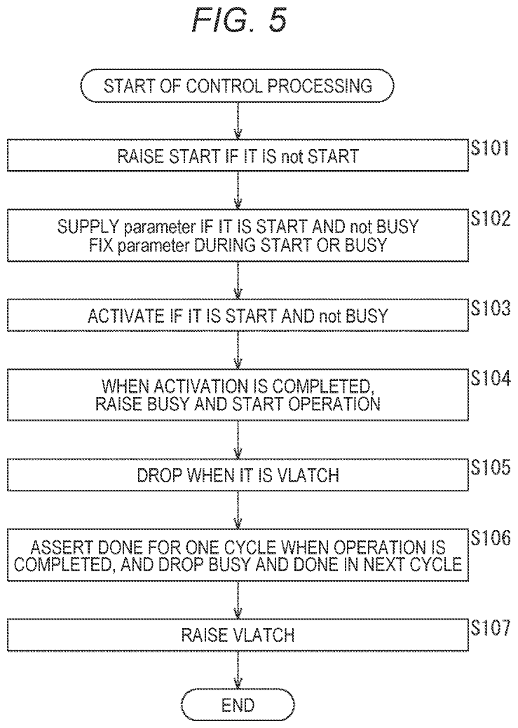

An example of a flow of control processing using these control signals will be described with reference to a flowchart of FIG. 5. For example, in a case where the control signal START is off (not START) at a predetermined timing, the control module 101 raises and turns on the control signal START (step S101).

In a case of the START and not the BUSY in step S102, that is, in a case where the control signal START is on and the control signal BUSY is off, the register module 102 supplies the parameters to the signal processing module 111. However, during the period of the START or BUSY, that is, while the control signal START or the control signal BUSY is on, the register module 102 fixes (does not switch) the parameter to be supplied.

In a case of the START and not the BUSY in step S103, the signal processing module 111 is activated. In step S104, when the activation is completed, the control signal BUSY is raised and turned on to start the operation (ellipse 131 in FIG. 4).

If it is the VLATCH in step S105, that is, in a case where the control signal VLATCH is on, the control module 101 drops the control signal VLATCH to turn it off (ellipse 134 in FIG. 4).

In step S106, in a case where the operation is completed, the signal processing module 111 asserts (turns on) the control signal DONE for one cycle, and drops and turns off the control signal BUSY and the control signal DONE in the next cycle (the ellipse 132 in FIG. 4).

In step S107, the control module 101 raises and turns on the control signal VLATCH (the ellipse 133 in FIG. 4). Thus, the register module 102 switches the parameter to be supplied to the signal processing module 111.

When the processing of step S107 ends, the control processing ends.

By performing the control processing as described above, the control module 101 can easily grasp the operating state of the signal processing module 111. Therefore, the register module 102 can change the parameter at an appropriate timing with respect to the progress of the pipeline processing. That is, the pipeline processing can be more easily controlled.

Note that, although only the signal processing module 111 has been described above, the same applies to the other signal processing modules (the signal processing modules 112 to 118) as described above. That is, the above description can be applied to other signal processing modules only by changing the signal processing module.

In other words, the signal processing modules are controlled independently of each other. That is, as illustrated in FIG. 2, the control module 101 supplies the control signal START to each of the signal processing modules 111 to 118 via signal lines independent of each other. Furthermore, the signal processing modules 111 to 118 supply the control signal BUSY and the control signal DONE to the control module 101 via signal lines independent of each other.

### 2. SECOND EMBODIMENT

<Signal Processing Device>

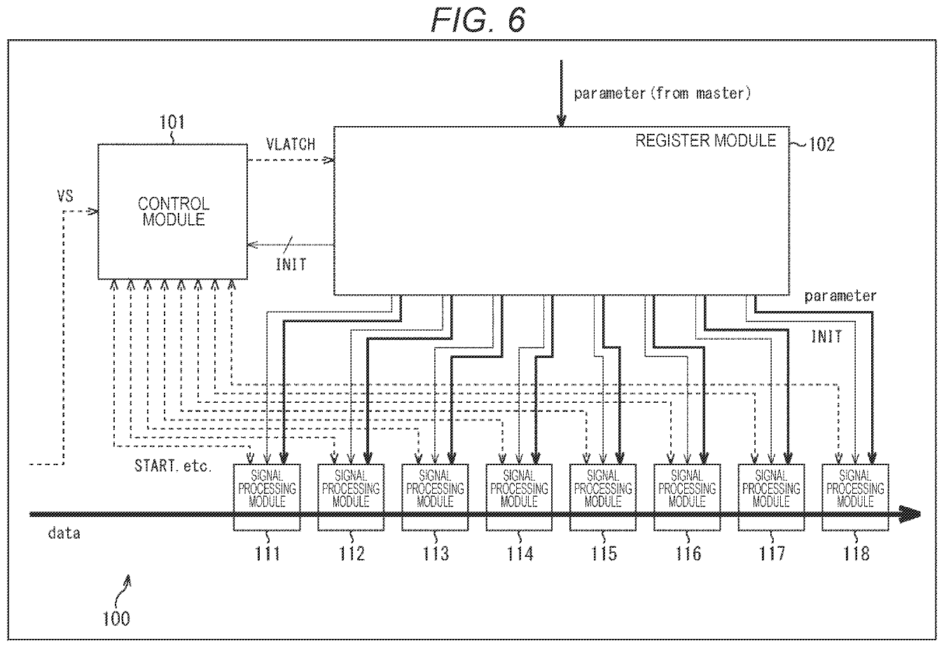

Note that software reset (initialization) may be performed. A main configuration example of the signal processing device 100 in that case is illustrated in FIG. 6. As illustrated in FIG. 6, in the signal processing device 100 in this case, the register module 102 can supply a control signal INIT to the signal processing modules 111 to 118. The control signal INIT is a control signal giving an instruction on initialization (software reset). That is, the register module 102 can cause the signal processing modules 111 to 118 to perform software reset.

As illustrated in FIG. 6, the register module 102 can supply the control signal INIT to each signal processing module via signal lines different from each other. Thus, the register module 102 can perform software reset on each of the signal processing modules 111 to 118 individually (independently of other signal processing modules). That is, the register module 102 can perform the software reset only on an arbitrary signal processing module. Accordingly, debugging work can be facilitated.

Furthermore, the register module 102 can also supply the control signal INIT to the control module 101. That is, the register module 102 can perform the software reset on the control module 101.

<Control Signal>

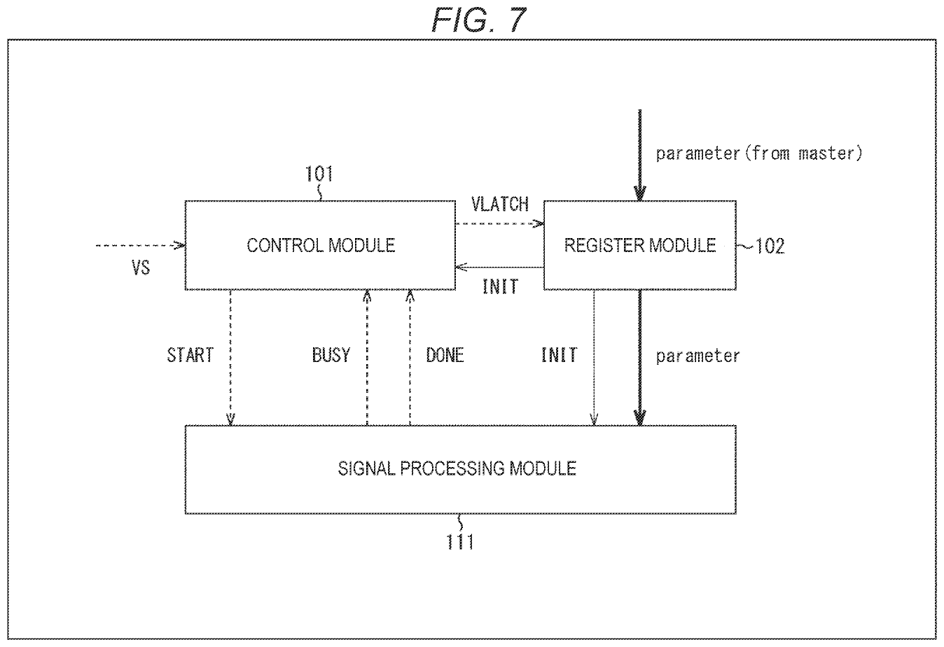

A control signal in this case will be described with reference to FIG. 7. Note that, in FIG. 7, only the signal processing module 111 will be described, but as in the case of FIG. 3, the description of the signal processing module 111 can also be applied to the other signal processing modules 112 to 118.

As illustrated in FIG. 7, the register module 102 provides the control signal INIT to the signal processing module 111. Furthermore, the register module 102 supplies the control signal INIT to the control module 101. Other configurations of the control signal are similar to those in the case of FIG. 3.

<Flow of Software Reset Processing>

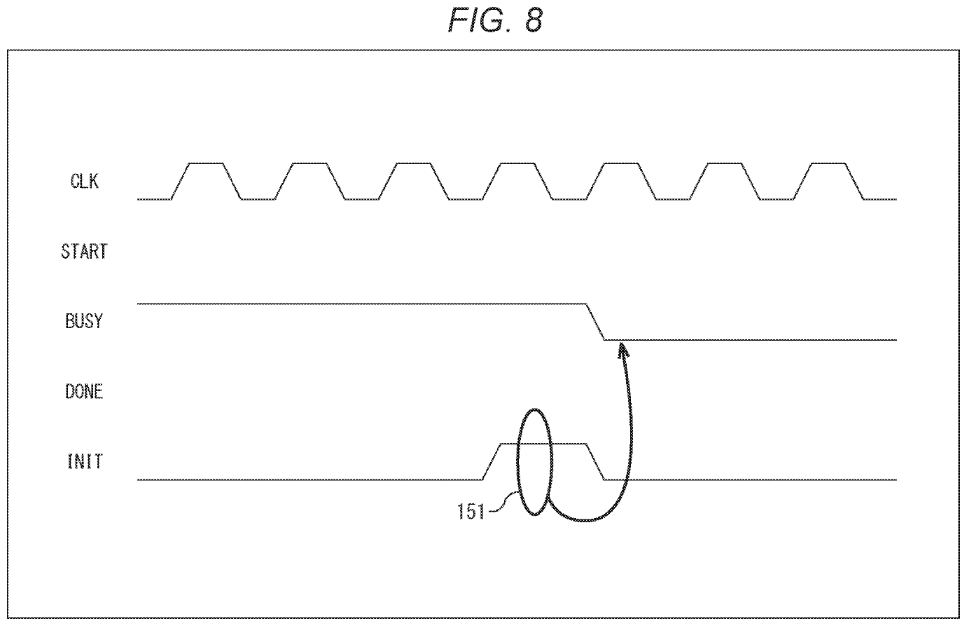

An example of a timing chart of these control signals is illustrated in FIG. 8. The control signal INIT is supplied (switched on and off) as illustrated in FIG. 8.

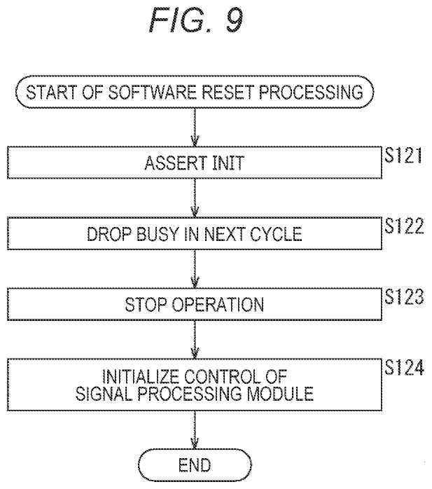

An example of a flow of software reset processing using the control signal INIT will be described with reference to a flowchart of FIG. 9. In a case where the software reset is performed, the register module 102 asserts the INIT in step S121. That is, the register module 102 turns on the control signal INIT (the ellipse 151 in FIG. 8).

In step S122, the signal processing module 111 supplied with the control signal INIT turns off the control signal BUSY in the next cycle. Then, the signal processing module 111 stops and initializes the operation in step S123.

Similarly, the control module 101 to which the control signal INIT is supplied initializes the control on the signal processing module 111 in step S124.

Note that, even when the signal processing module 111 and the control module 101 are initialized in this manner, the register module 102 does not initialize (skips its own initialization). That is, the parameter that is set to the signal processing module 111 is held. In this manner, the parameter can be used at the time of restart after releasing (turning off) the control signal INIT. Of course, the register module 102 may also be initialized (set parameters are discarded) in accordance with the initialization by the signal processing module 111 and the control module 101.

When the processing of step S124 ends, the software reset processing ends. By performing the software reset processing in this manner, the register module 102 can easily initialize (software reset) the signal processing module 111 and the control module 101.

Note that, although only the signal processing module 111 has been described above, the same applies to the other signal processing modules (the signal processing modules 112 to 118) as described above. That is, the above description can be applied to other signal processing modules only by changing the signal processing module. In other words, the register module 102 can initialize each signal processing module independently of one another.

### 3. THIRD EMBODIMENT

<Signal Processing Device>

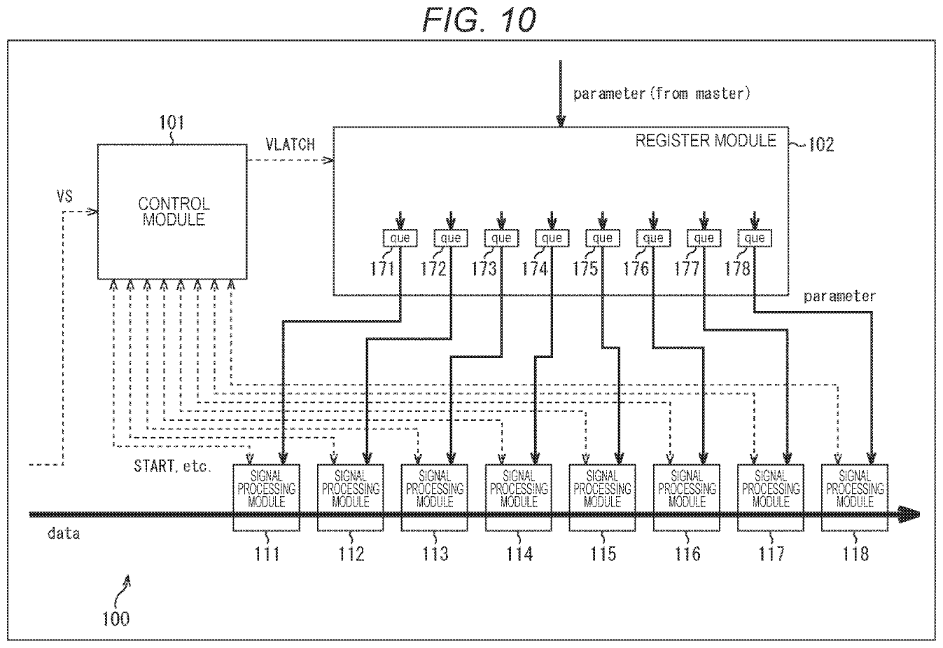

The register module 102 may supply the parameter to each signal processing module via a queue. FIG. 10 illustrates a main configuration example of the signal processing device 100 in that case. As illustrated in FIG. 10, in the signal processing device 100 in this case, the register module 102 includes queues 171 to 178. The queues 171 to 178 correspond to the signal processing modules 111 to 118, respectively, and temporarily hold parameters supplied to the respective signal processing modules in a first-in first-out manner.

That is, the register module 102 supplies the parameter to be supplied to the signal processing module 111 to the signal processing module 111 via the queue 171 (after temporarily holding the parameter in the queue 171). Similarly, parameters are supplied to the other signal processing modules via respective corresponding queues.

As described above, by interposing the queue in a parameter line between the register module 102 and each signal processing module, each module can follow even in a case where setting is completely different between the frames, so that processing is possible when a plurality of frames having different features is handled in the entire signal processing.

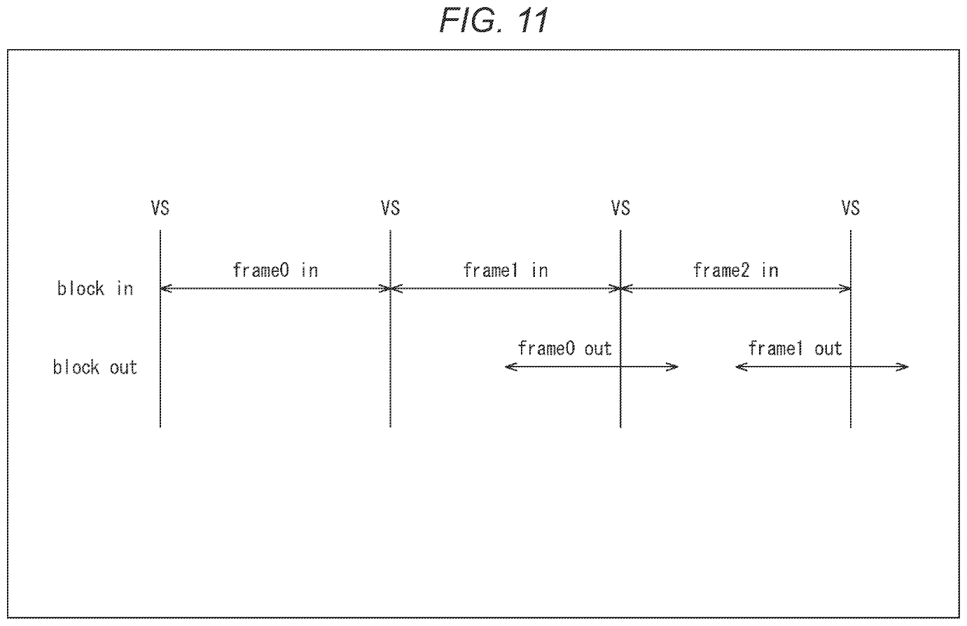

For example, as illustrated in FIG. 11, while the signal processing module 118 outputs the data of the frame 0, the data of the frame 2 may be input to the signal processing module 111. In a case where the parameter is changed in each frame, the control is facilitated by providing the queues 171 to 178 as described above.

<Flow of Control Processing>

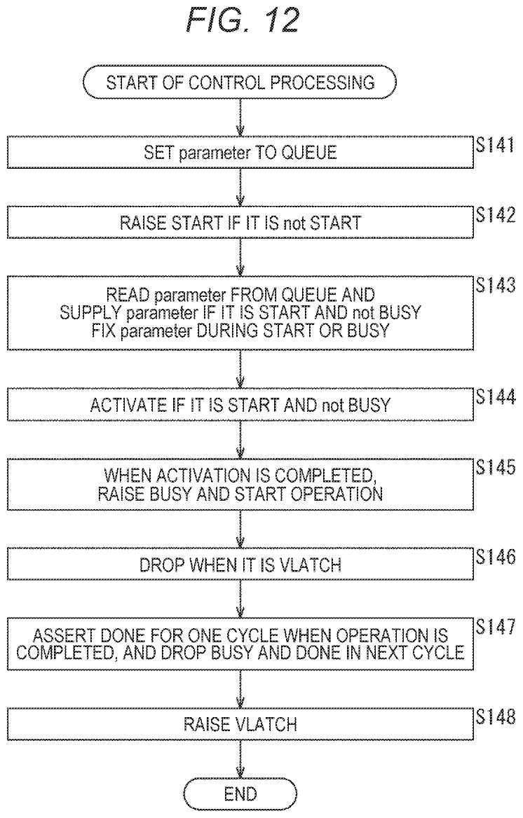

An example of a flow of control processing in this case will be described with reference to a flowchart of FIG. 12. When the control processing is started, in step S141, the register module 102 sets (holds) the parameter to be supplied to the signal processing module 111 in the queue 171 that is the queue corresponding to the signal processing module.

The processing of step S142 is executed similarly to step S101 in FIG. 5.

In a case of the START and not the BUSY in step S143, that is, in a case where the control signal START is on and the control signal BUSY is off, the register module 102 reads the parameter from the queue 171 and supplies the parameter to the signal processing module 111. However, during the period of the START or BUSY, that is, while the control signal START or the control signal BUSY is on, the register module 102 fixes (does not switch) the parameter to be supplied.

Each processing of steps S144 to S148 is executed similarly to each processing of steps S103 to S107 of FIG. 5.

Then, when the processing of step S148 ends, the control processing ends. By performing the control processing as described above, each module can follow even in a case where the setting is completely different between the frames, so that processing is possible when a plurality of frames having different features is handled in the entire signal processing.

### 4. FOURTH EMBODIMENT

<Signal Processing Device>

The register module 102 may be allowed to switch (change) the parameter to be supplied to the signal processing module within the vertical synchronization period. For example, at a time of dual frequency operation in indirect time of flight (iToF) signal processing, it may be possible to switch between a low frequency parameter and a high frequency parameter within a vertical synchronization period.

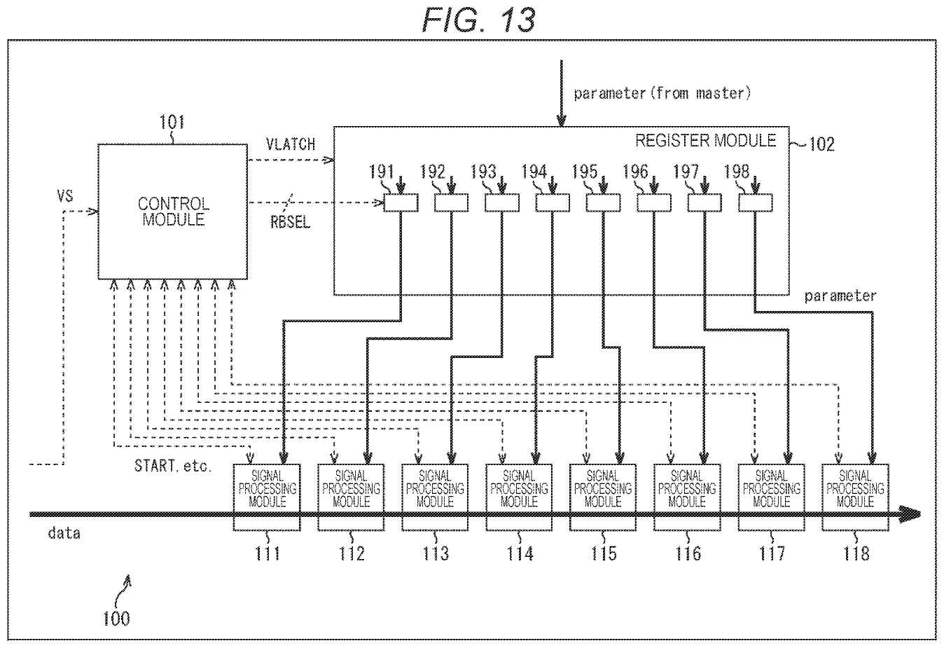

FIG. 13 illustrates a main configuration example of the signal processing device 100 in that case. As illustrated in FIG. 13, in the signal processing device 100 in this case, the register module 102 includes parameter selection units 191 to 198. The parameter selection units 191 to 198 correspond to the signal processing modules 111 to 118, respectively, and select parameters to be supplied to respective signal processing modules from among a plurality of choices of parameters. That is, the parameters selected by the parameter selection units 191 to 198 are supplied to the respective signal processing modules.

Note that a control signal RBSEL is supplied from the control module 101 to each of the parameter selection units 191 to 198. The control signal RBSEL is a control signal controlling parameter selection. That is, the control module 101 controls which parameter is selected by the parameter selection units 191 to 198 using the control signal RBSEL. In other words, the parameter selection units 191 to 198 select parameters under the control of the control module 101.

<Parameter Selection Unit>

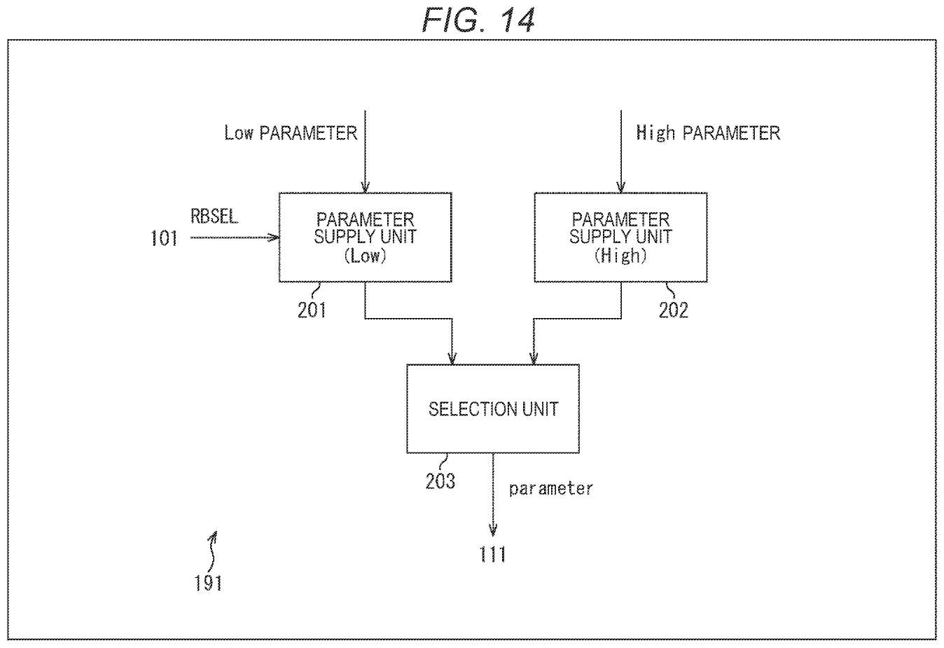

A main configuration example of the parameter selection unit 191 is illustrated in FIG. 14. As illustrated in FIG. 14, the parameter selection unit 191 includes a parameter supply unit 201, a parameter supply unit 202, and a selection unit 203. The parameter supply unit 201 and the parameter supply unit 202 supply different choices of parameters to the selection unit 203. The selection unit 203 selects a parameter to be supplied to the signal processing module 111 from among these choices, and supplies the selected parameter to the signal processing module 111.

For example, as described above, in a case of the dual frequency operation in the iToF signal processing, the parameter supply unit 201 supplies the low frequency parameter (low parameter) to the selection unit 203, and the parameter supply unit 202 supplies the high frequency parameter (high parameter) to the selection unit 203. The control signal RBSEL is supplied from the control module 101 to the selection unit 203. The selection unit 203 selects one of the supplied parameters in accordance with the control signal RBSEL, and supplies the selected parameter to the signal processing module 111.

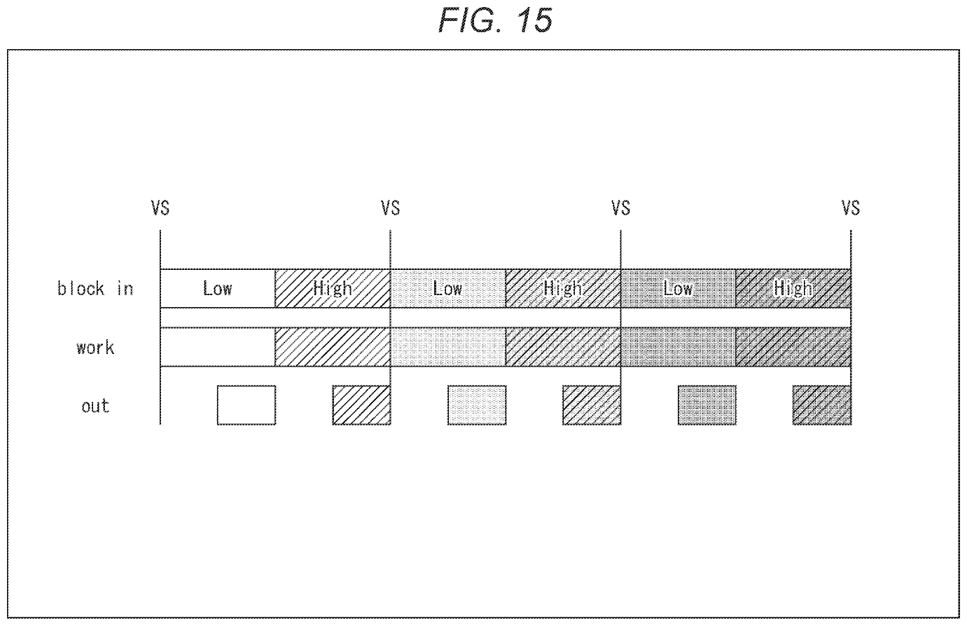

In this manner, for example, as illustrated in FIG. 15, the register module 102 can supply the low frequency parameter and the high frequency parameter in a switched manner even within a vertical synchronization (VS) period. Thus, the signal processing module 111 can perform both processing for low frequency and processing for high frequency. That is, the dual frequency operation can be performed.

Note that, in FIG. 14, the number of choices of parameters is described as two, but the number of choices of parameters is arbitrary. The parameter selection unit 191 may select a parameter to be supplied to the signal processing module 111 from among three or more choices of parameters.

Furthermore, in FIG. 14, only the signal processing module 111 has been described, but the same applies to the other signal processing modules (signal processing modules 112 to 118). That is, the above description can be applied to other signal processing modules only by changing the signal processing module. In other words, the register module 102 can switch parameters supplied to respective signal processing modules independently of each other.

<Flow of Control Processing>

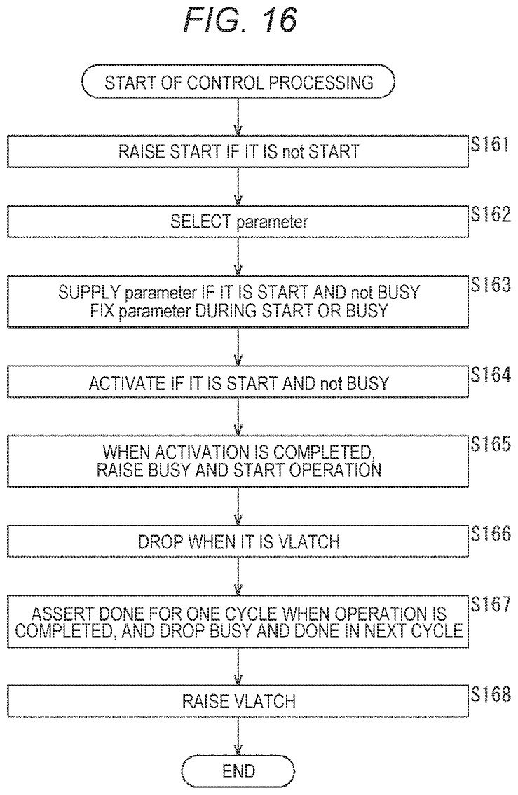

An example of a flow of control processing in this case will be described with reference to a flowchart of FIG. 16. The processing of step S161 is performed similarly to the processing of step S101 of FIG. 5.

In step S162, the parameter selection units 191 to 198 select parameters in accordance with the control signal RBSEL.

In a case of the START and not the BUSY in step S163, that is, in a case where the control signal START is on and the control signal BUSY is off, the register module 102 supplies the parameter selected in step S162 to the signal processing module 111. However, during the period of the START or BUSY, that is, while the control signal START or the control signal BUSY is on, the register module 102 fixes (does not switch) the parameter to be supplied.

Each processing of steps S164 to S168 is executed similarly to each processing of steps S103 to S107 of FIG. 5.

Then, when the processing of step S168 ends, the control processing ends. By performing the control processing as described above, the parameters can be switched even within the vertical synchronization (VS) period. Thus, a wider variety of signal processes can be performed.

Note that the parameter selection units 191 to 198 described above may be provided in the signal processing modules 111 to 118, but in this case, the number of wirings between the register module 102 and the signal processing module 111 increases.

### 5. FIFTH EMBODIMENT

<Signal Processing Device>

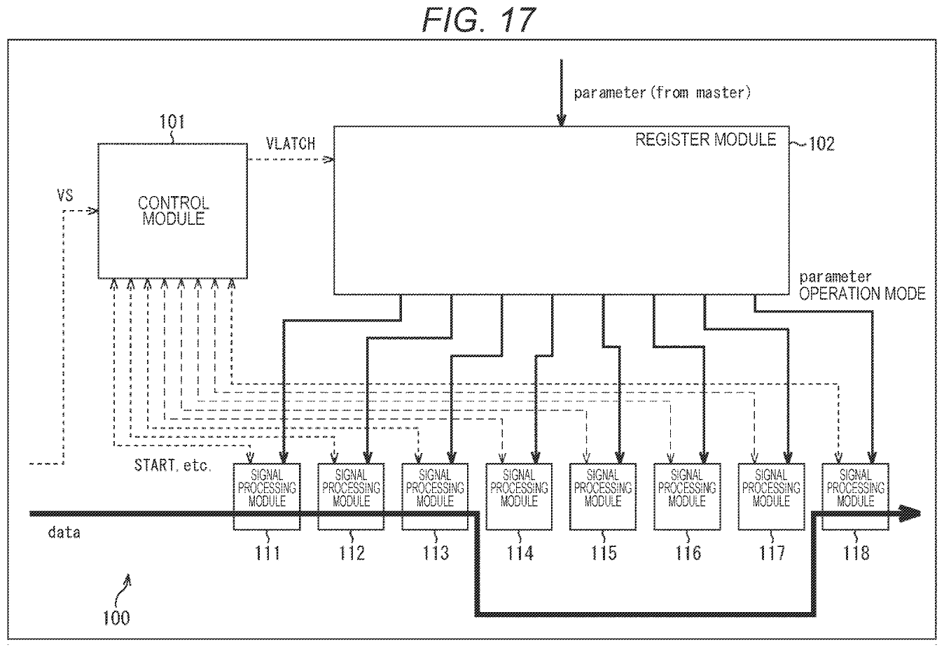

In the pipeline processing, the signal processing modules 111 to 118 may bypass data without performing signal processes. FIG. 17 illustrates a main configuration example of the signal processing device 100 in that case. In this case, the signal processing modules 111 to 118 include, as operation modes, a normal mode in which signal processes are performed and a bypass mode in which signal processes are skipped. Furthermore, each of the signal processing modules 111 to 118 has a detour data path, and in the bypass mode, that is, in a case where signal processes are skipped, signals (data) to be processed are caused to pass through the detour data path.

In a case of the example of FIG. 17, the signal processing modules 111 to 113 and the signal processing module 118 perform signal processing in the normal mode, and the signal processing modules 114 to 117 skip signal processing in the bypass mode (bypass the data path).

Note that, in this case, the register module 102 is capable of supplying not only parameters but also control information specifying the operation mode to each signal processing module. For example, the register module 102 may select, for each signal processing module, whether to set the operation mode to the normal mode or the bypass mode, and supply a control signal corresponding to the selection result to each signal processing module. That is, each signal processing module selects the operation mode designated by the register module 102.

Furthermore, the control module 101 does not supply the control signal START (does not turn on but keeps off) to the signal processing module in the bypass mode.

In this manner, some or all of the signal processes forming the pipeline processing can be omitted. In other words, signal processes to be executed as the pipeline processing can be selected. Therefore, the signal processing device 100 can perform a wider variety of pipeline processing.

Note that, although the normal mode and the bypass mode have been described above as examples of the operation mode, the operation mode is arbitrary and is not limited to these examples. In addition, the number of operation modes to be prepared is also arbitrary, and may be three or more. Furthermore, although it has been described that the register module 102 controls the operation mode, the embodiment is not limited thereto, and the control module 101 may control the operation mode, or the signal processing module itself may determine the operation mode. Moreover, another signal processing unit may control the operation mode.

<Flow of Control Processing>

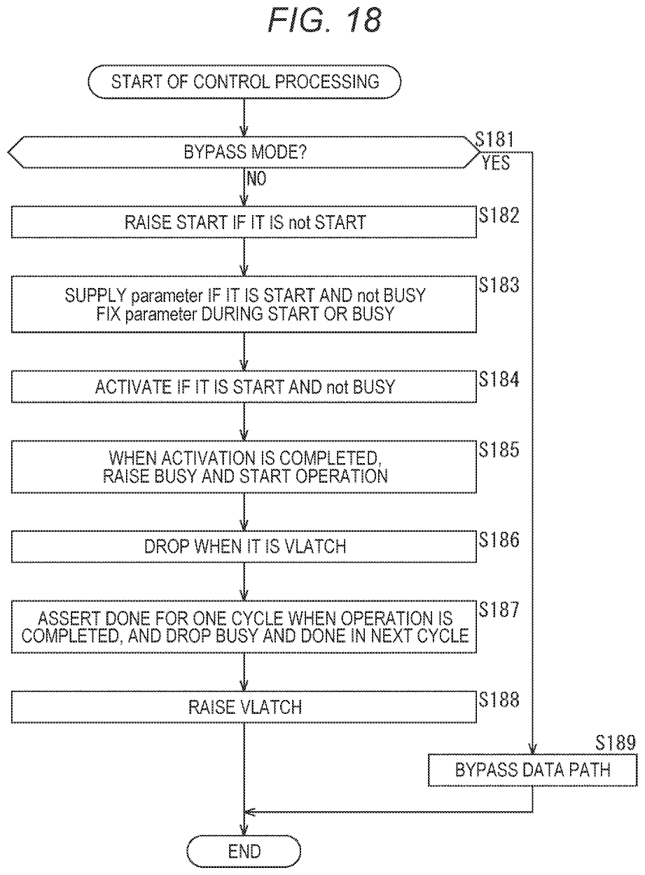

An example of a flow of control processing in this case will be described with reference to a flowchart of FIG. 18. When the control processing is started, in step S181, the signal processing module 111 determines whether or not its own operation mode that has been selected by the register module 102 is the bypass mode on the basis of the control signal supplied from the register module 102. In a case where it is determined that the bypass mode is not set (the normal mode is set), the process proceeds to step S182.

Since the mode is the normal mode, each processing of steps S182 to S188 is executed similarly to the processing of steps S101 to S107 in FIG. 5. When the processing of step S188 ends, the control processing ends.

Furthermore, in a case where it is determined in step S181 that the bypass mode has been selected, the process moves on to step S189. In step S189, the signal processing module 111 bypasses the data path without performing signal processes.

When the processing of step S189 ends, the control processing ends.

By executing the control processing in this manner, some or all of the signal processes forming the pipeline processing can be omitted. In other words, signal processes to be executed as the pipeline processing can be selected. Therefore, the signal processing device 100 can perform a wider variety of pipeline processing.

Note that, although the signal processing module 111 has been described here, the same applies to the other signal processing modules (the signal processing modules 112 to 118). That is, the above description can be applied to other signal processing modules only by changing the signal processing module. In other words, the register module 102 can switch parameters supplied to respective signal processing modules independently of each other.

### 6. SIXTH EMBODIMENT

<Signal Processing Device>

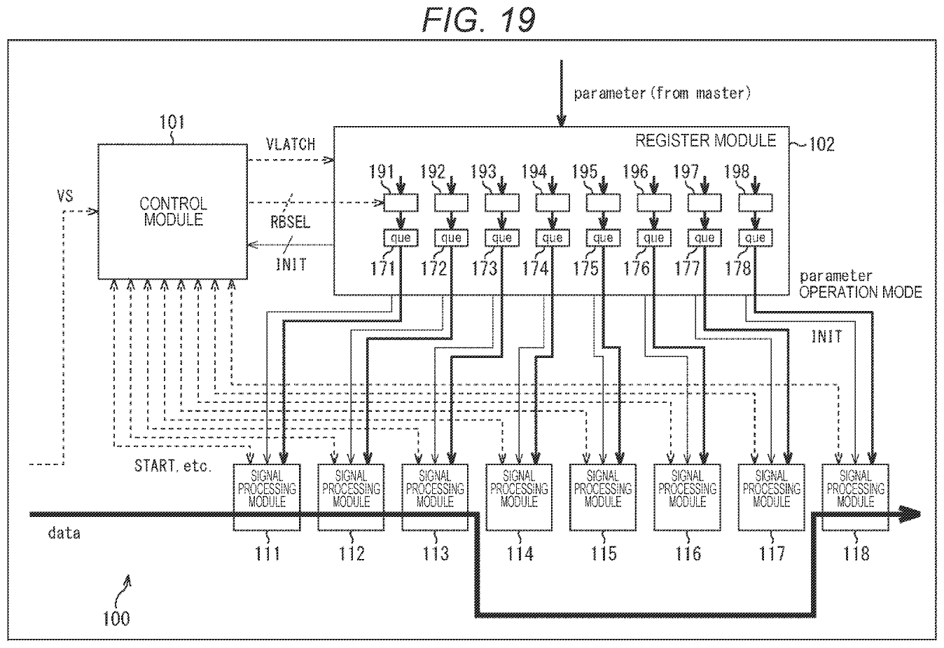

The above-described embodiments can be appropriately combined and applied. For example, all of the first to fifth embodiments may be applied. FIG. 19 illustrates a main configuration example of the signal processing device 100 in that case.

In this case, similarly to the first embodiment, the control module 101 supplies the control signal VLATCH to the register module 102 to give an instruction on a timing of switching a parameter. The register module 102 changes the parameter to be supplied to the signal processing module at the timing based on the control signal VLATCH.

Furthermore, the control module 101 supplies the control signal START to the signal processing module 111 and instructs the signal processing module 111 to start a signal process. The signal processing module 111 starts an operation of the signal process at the timing based on the control signal START.

Furthermore, the signal processing module 111 supplies the control signal BUSY and the control signal DONE to the control module 101. The control signal BUSY is a control signal indicating that an operation is being performed. The control signal DONE is a control signal indicating that an operation is completed. The control module 101 can easily grasp the operating state of the signal processing module 111 on the basis of these control signals. The control module 101 supplies the control signal VLATCH on the basis of these control signals. Therefore, the register module 102 can change the parameter at an appropriate timing with respect to the progress of the pipeline processing. That is, the pipeline processing can be more easily controlled.

Further, similarly to the second embodiment, the register module 102 can supply the control signal INIT to the signal processing modules 111 to 118 to perform the software reset. Furthermore, the register module 102 can also supply the control signal INIT to the control module 101 to perform the software reset.

Moreover, similarly to the third embodiment, the register module 102 includes the queues 171 to 178, and supplies the parameters to respective signal processing modules via the queues.

Furthermore, similarly to the fourth embodiment, the register module 102 includes the parameter selection units 191 to 198, and supplies the parameters selected by the parameter selection units 191 to 198 to respective signal processing modules.

Moreover, similarly to the fifth embodiment, the signal processing modules 111 to 118 include, as operation modes, the normal mode in which signal processes are performed and the bypass mode in which signal processes are skipped. Furthermore, each of the signal processing modules 111 to 118 has a detour data path, and in the bypass mode, that is, in a case where signal processes are skipped, signals (data) to be processed are caused to pass through the detour data path.

Then, the register module 102 selects whether to set the operation mode to the normal mode or the bypass mode, and supplies a control signal corresponding to the selection result to each signal processing module. Furthermore, the control module 101 does not supply the control signal START (does not turn on but keeps off) to the signal processing module in the bypass mode.

That is, in the signal processing device 100 in this case, the control module 101 supplies the START, which is a control signal giving an instruction to start the signal process, to the signal processing modules 111 to 118. Furthermore, the control module 101 supplies the VLATCH, which is a control signal giving an instruction to switch the parameter to be supplied, to the register module 102. The register module 102 supplies the INIT, which is a control signal giving an instruction on initialization, to the signal processing modules 111 to 118. Further, the register module 102 supplies parameters selected from among a plurality of parameters by the parameter selection units 191 to 198 to the signal processing modules 111 to 118 via the queues 171 to 178. Furthermore, the register module 102 supplies a control signal controlling the operation mode to the normal mode or the bypass mode to the parameter selection units 191 to 198.

Thus, the signal processing device 100 can obtain effects similar to those described above in the first to fifth embodiments.

### 7. SEVENTH EMBODIMENT

<Signal Processing Device>

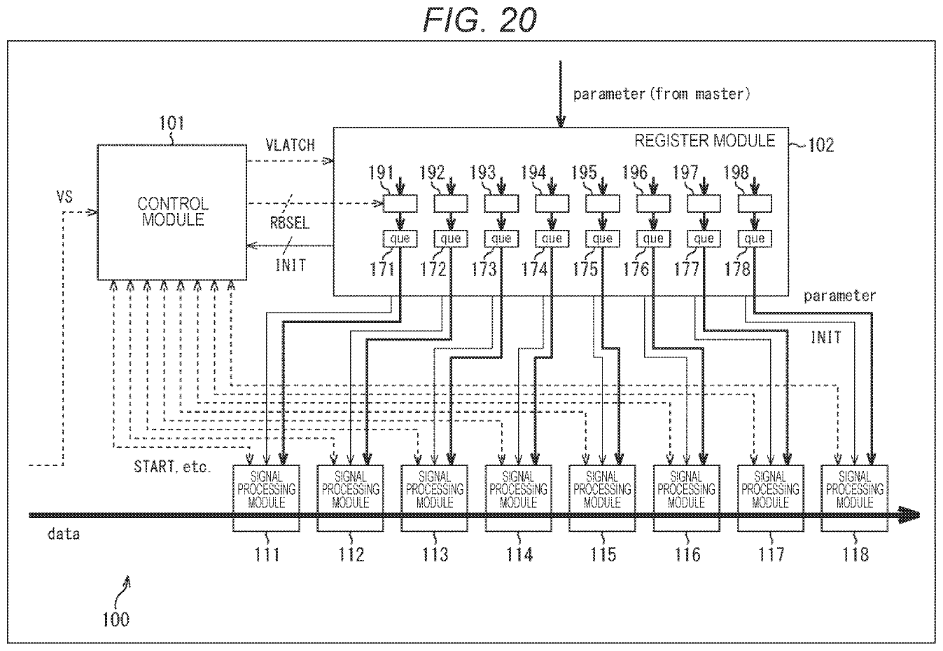

The above-described embodiments can be appropriately combined and applied. For example, all of the first to fourth embodiments may be applied. FIG. 20 illustrates a main configuration example of the signal processing device 100 in that case.

In this case, similarly to the first embodiment, the control module 101 supplies the control signal VLATCH to the register module 102 to give an instruction on a timing of switching a parameter. The register module 102 changes the parameter to be supplied to the signal processing module at the timing based on the control signal VLATCH.

Furthermore, the control module 101 supplies the control signal START to the signal processing module 111 and instructs the signal processing module 111 to start a signal process. The signal processing module 111 starts an operation of the signal process at the timing based on the control signal START.

Furthermore, the signal processing module 111 supplies the control signal BUSY and the control signal DONE to the control module 101. The control signal BUSY is a control signal indicating that an operation is being performed. The control signal DONE is a control signal indicating that an operation is completed. The control module 101 can easily grasp the operating state of the signal processing module 111 on the basis of these control signals. The control module 101 supplies the control signal VLATCH on the basis of these control signals. Therefore, the register module 102 can change the parameter at an appropriate timing with respect to the progress of the pipeline processing. That is, the pipeline processing can be more easily controlled.

Further, similarly to the second embodiment, the register module 102 can supply the control signal INIT to the signal processing modules 111 to 118 to perform the software reset. Furthermore, the register module 102 can also supply the control signal INIT to the control module 101 to perform the software reset.

Moreover, similarly to the third embodiment, the register module 102 includes the queues 171 to 178, and supplies the parameters to respective signal processing modules via the queues.

Furthermore, similarly to the fourth embodiment, the register module 102 includes the parameter selection units 191 to 198, and supplies the parameters selected by the parameter selection units 191 to 198 to respective signal processing modules.

That is, in the signal processing device 100 in this case, the control module 101 supplies the START, which is a control signal giving an instruction to start the signal process, to the signal processing modules 111 to 118. Furthermore, the control module 101 supplies the VLATCH, which is a control signal giving an instruction to switch the parameter to be supplied, to the register module 102. The register module 102 supplies the INIT, which is a control signal giving an instruction on initialization, to the signal processing modules 111 to 118. Furthermore, the register module 102 supplies parameters selected from among a plurality of parameters by the parameter selection units 191 to 198 to the signal processing modules 111 to 118 via the queues 171 to 178.

Thus, the signal processing device 100 can obtain effects similar to those described above in the first to fourth embodiments.

### 8. EIGHTH EMBODIMENT

<Signal Processing Device>

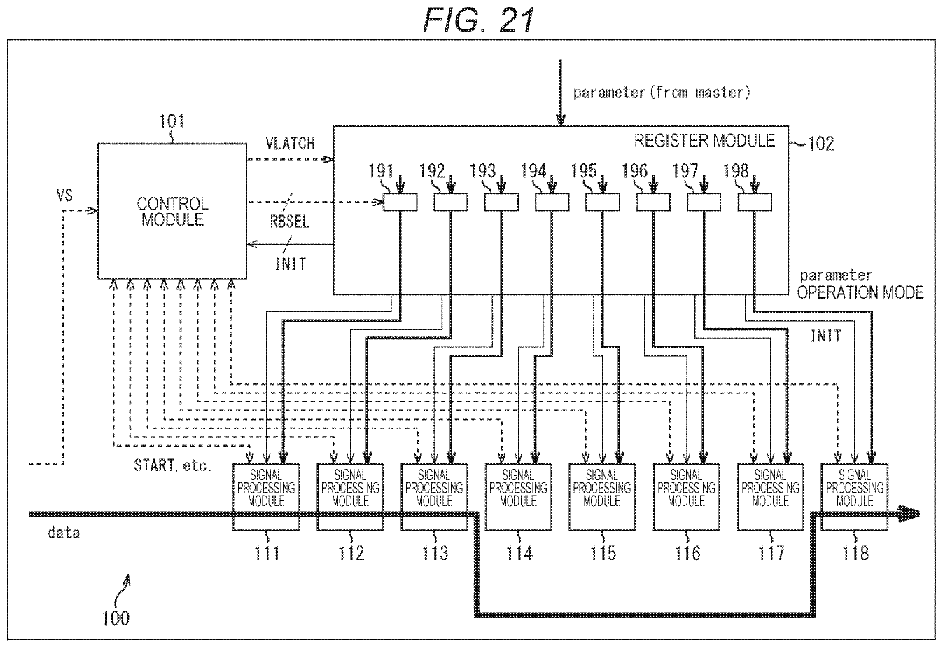

The above-described embodiments can be appropriately combined and applied. For example, the first embodiment, the second embodiment, the fourth embodiment, and the fifth embodiment may be applied. FIG. 21 illustrates a main configuration example of the signal processing device 100 in that case.

In this case, similarly to the first embodiment, the control module 101 supplies the control signal VLATCH to the register module 102 to give an instruction on a timing of switching a parameter. The register module 102 changes the parameter to be supplied to the signal processing module at the timing based on the control signal VLATCH.

Furthermore, the control module 101 supplies the control signal START to the signal processing module 111 and instructs the signal processing module 111 to start a signal process. The signal processing module 111 starts an operation of the signal process at the timing based on the control signal START.

Furthermore, the signal processing module 111 supplies the control signal BUSY and the control signal DONE to the control module 101. The control signal BUSY is a control signal indicating that an operation is being performed. The control signal DONE is a control signal indicating that an operation is completed. The control module 101 can easily grasp the operating state of the signal processing module 111 on the basis of these control signals. The control module 101 supplies the control signal VLATCH on the basis of these control signals. Therefore, the register module 102 can change the parameter at an appropriate timing with respect to the progress of the pipeline processing. That is, the pipeline processing can be more easily controlled.

Further, similarly to the second embodiment, the register module 102 can supply the control signal INIT to the signal processing modules 111 to 118 to perform the software reset. Furthermore, the register module 102 can also supply the control signal INIT to the control module 101 to perform the software reset.

Furthermore, similarly to the fourth embodiment, the register module 102 includes the parameter selection units 191 to 198, and supplies the parameters selected by the parameter selection units 191 to 198 to respective signal processing modules.

Moreover, similarly to the fifth embodiment, the signal processing modules 111 to 118 include, as operation modes, the normal mode in which signal processes are performed and the bypass mode in which signal processes are skipped. Furthermore, each of the signal processing modules 111 to 118 has a detour data path, and in the bypass mode, that is, in a case where signal processes are skipped, signals (data) to be processed are caused to pass through the detour data path.

Then, the register module 102 selects whether to set the operation mode to the normal mode or the bypass mode, and supplies a control signal corresponding to the selection result to each signal processing module. Furthermore, the control module 101 does not supply the control signal START (does not turn on but keeps off) to the signal processing module in the bypass mode.

That is, in the signal processing device 100 in this case, the control module 101 supplies the START, which is a control signal giving an instruction to start the signal process, to the signal processing modules 111 to 118. Furthermore, the control module 101 supplies the VLATCH, which is a control signal giving an instruction to switch the parameter to be supplied, to the register module 102. The register module 102 supplies the INIT, which is a control signal giving an instruction on initialization, to the signal processing modules 111 to 118. Further, the register module 102 supplies parameters selected from among a plurality of parameters by the parameter selection units 191 to 198 to the signal processing modules 111 to 118. Furthermore, the register module 102 supplies the control signal controlling the operation mode to the normal mode or the bypass mode to the parameter selection units 191 to 198.

Thus, the signal processing device 100 can obtain effects similar to those described above in the first embodiment, the second embodiment, the fourth embodiment, and the fifth embodiment.

### 9. NINTH EMBODIMENT

<Signal Processing Device>

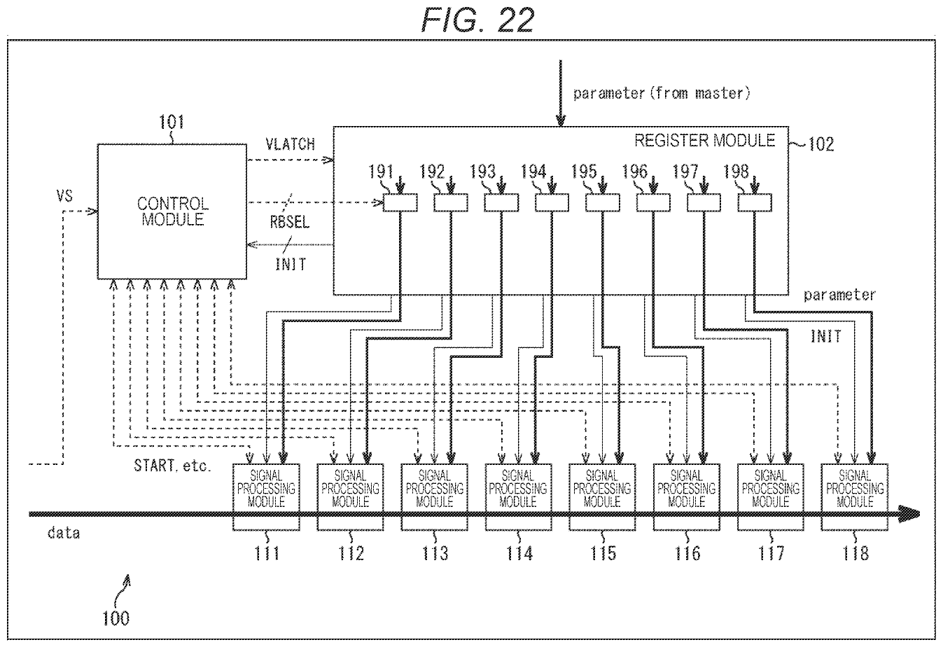

The above-described embodiments can be appropriately combined and applied. For example, all of the first embodiment, the second embodiment, and the fourth embodiment may be applied. FIG. 22 illustrates a main configuration example of the signal processing device 100 in that case.

In this case, similarly to the first embodiment, the control module 101 supplies the control signal VLATCH to the register module 102 to give an instruction on a timing of switching a parameter. The register module 102 changes the parameter to be supplied to the signal processing module at the timing based on the control signal VLATCH.

Furthermore, the control module 101 supplies the control signal START to the signal processing module 111 and instructs the signal processing module 111 to start a signal process. The signal processing module 111 starts an operation of the signal process at the timing based on the control signal START.

Furthermore, the signal processing module 111 supplies the control signal BUSY and the control signal DONE to the control module 101. The control signal BUSY is a control signal indicating that an operation is being performed. The control signal DONE is a control signal indicating that an operation is completed. The control module 101 can easily grasp the operating state of the signal processing module 111 on the basis of these control signals. The control module 101 supplies the control signal VLATCH on the basis of these control signals. Therefore, the register module 102 can change the parameter at an appropriate timing with respect to the progress of the pipeline processing. That is, the pipeline processing can be more easily controlled.

Further, similarly to the second embodiment, the register module 102 can supply the control signal INIT to the signal processing modules 111 to 118 to perform the software reset. Furthermore, the register module 102 can also supply the control signal INIT to the control module 101 to perform the software reset.

Furthermore, similarly to the fourth embodiment, the register module 102 includes the parameter selection units 191 to 198, and supplies the parameters selected by the parameter selection units 191 to 198 to respective signal processing modules.

That is, in the signal processing device 100 in this case, the control module 101 supplies the START, which is a control signal giving an instruction to start the signal process, to the signal processing modules 111 to 118. Furthermore, the control module 101 supplies the VLATCH, which is a control signal giving an instruction to switch the parameter to be supplied, to the register module 102. The register module 102 supplies the INIT, which is a control signal giving an instruction on initialization, to the signal processing modules 111 to 118. Furthermore, the register module 102 supplies parameters selected from among a plurality of parameters by the parameter selection units 191 to 198 to the signal processing modules 111 to 118.

Thus, the signal processing device 100 can obtain effects similar to those described above in the first embodiment, the second embodiment, and the fourth embodiment.

### 10. TENTH EMBODIMENT

<Signal Processing Device>

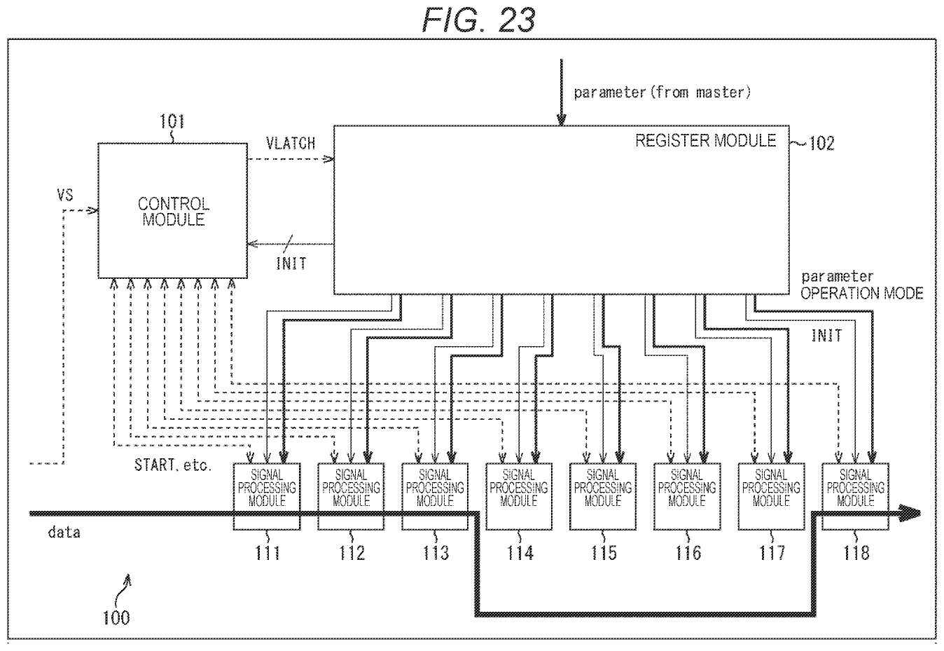

The above-described embodiments can be appropriately combined and applied. For example, all of the first embodiment, the second embodiment, and the fifth embodiment may be applied. FIG. 23 illustrates a main configuration example of the signal processing device 100 in that case.

In this case, similarly to the first embodiment, the control module 101 supplies the control signal VLATCH to the register module 102 to give an instruction on a timing of switching a parameter. The register module 102 changes the parameter to be supplied to the signal processing module at the timing based on the control signal VLATCH.

Furthermore, the control module 101 supplies the control signal START to the signal processing module 111 and instructs the signal processing module 111 to start a signal process. The signal processing module 111 starts an operation of the signal process at the timing based on the control signal START.

Furthermore, the signal processing module 111 supplies the control signal BUSY and the control signal DONE to the control module 101. The control signal BUSY is a control signal indicating that an operation is being performed. The control signal DONE is a control signal indicating that an operation is completed. The control module 101 can easily grasp the operating state of the signal processing module 111 on the basis of these control signals. The control module 101 supplies the control signal VLATCH on the basis of these control signals. Therefore, the register module 102 can change the parameter at an appropriate timing with respect to the progress of the pipeline processing. That is, the pipeline processing can be more easily controlled.

Further, similarly to the second embodiment, the register module 102 can supply the control signal INIT to the signal processing modules 111 to 118 to perform the software reset. Furthermore, the register module 102 can also supply the control signal INIT to the control module 101 to perform the software reset.

Moreover, similarly to the fifth embodiment, the signal processing modules 111 to 118 include, as operation modes, the normal mode in which signal processes are performed and the bypass mode in which signal processes are skipped. Furthermore, each of the signal processing modules 111 to 118 has a detour data path, and in the bypass mode, that is, in a case where signal processes are skipped, signals (data) to be processed are caused to pass through the detour data path.

Then, the register module 102 selects whether to set the operation mode to the normal mode or the bypass mode, and supplies a control signal corresponding to the selection result to each signal processing module. Furthermore, the control module 101 does not supply the control signal START (does not turn on but keeps off) to the signal processing module in the bypass mode.

That is, in the signal processing device 100 in this case, the control module 101 supplies the START, which is a control signal giving an instruction to start the signal process, to the signal processing modules 111 to 118. Furthermore, the control module 101 supplies the VLATCH, which is a control signal giving an instruction to switch the parameter to be supplied, to the register module 102. The register module 102 supplies the INIT, which is a control signal giving an instruction on initialization, to the signal processing modules 111 to 118. Further, the register module 102 supplies the parameters to the signal processing modules 111 to 118. Furthermore, the register module 102 supplies the control signal controlling the operation mode to the normal mode or the bypass mode to the parameter selection units 191 to 198.

Thus, the signal processing device 100 can obtain effects similar to those described above in the first embodiment, the second embodiment, and the fifth embodiment.

### 11. ELEVENTH EMBODIMENT

<Signal Processing Device>

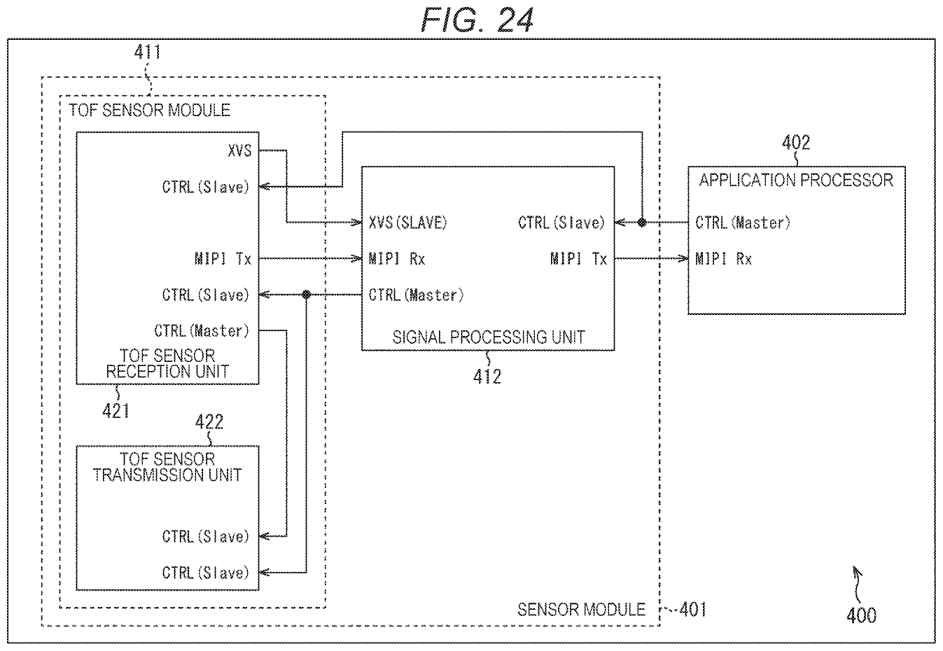

The present technology can also be applied as a part of a device, such as a signal processing unit or a module. A signal processing device 400 illustrated in FIG. 24 is a device that performs signal processing related to ToF. As illustrated in FIG. 24, the signal processing device 400 has a sensor module 401 and an application processor 402.

The sensor module 401 is a module that performs detection by the ToF sensor and signal processing on the detection result. The application processor 402 controls the sensor module 401 to supply sensing data of ToF and perform application processing using the sensing data.

The sensor module 401 includes a ToF sensor module 411 and a signal processing unit 412. The ToF sensor module 411 is a module that performs sensing based on ToF. The ToF sensor module 411 includes a ToF sensor reception unit 421 and a ToF sensor transmission unit 422. The ToF sensor transmission unit 422 transmits laser light, and the ToF sensor reception unit 421 detects reflected light by an object and supplies a detection signal thereof to the signal processing unit 412.

The signal processing unit 412 performs, for example, signal processing on the detection signal. For example, the signal processing unit 412 performs pipeline processing (performs a plurality of signal processes in series) on the detection signal (the output signal of the ToF sensor reception unit 421). The signal processing unit 412 supplies a signal processing result thereof to the application processor 402. Note that the ToF sensor module 411 and the signal processing unit 412 may be arranged on the same plane as illustrated in the drawing or may be stacked.

The present technology may be applied to the signal processing unit 412 of such a signal processing device 400. That is, any of the signal processing devices 100 described in the first to tenth embodiments may be applied as the signal processing unit 412. In this manner, the pipeline processing can be more easily controlled.

In other words, the present technology can also be applied to the sensor module 401 including the signal processing unit 412. Furthermore, the present technology can also be applied to the signal processing device 400.

### 12. APPENDIX

<Computer>

The series of processes described above can be executed by hardware or can be executed by software. In a case where the series of processes is executed by software, a program constituting the software is installed in a computer. Here, the computer includes a computer incorporated in dedicated hardware, a general-purpose personal computer for example that can execute various functions by installing various programs, and the like.

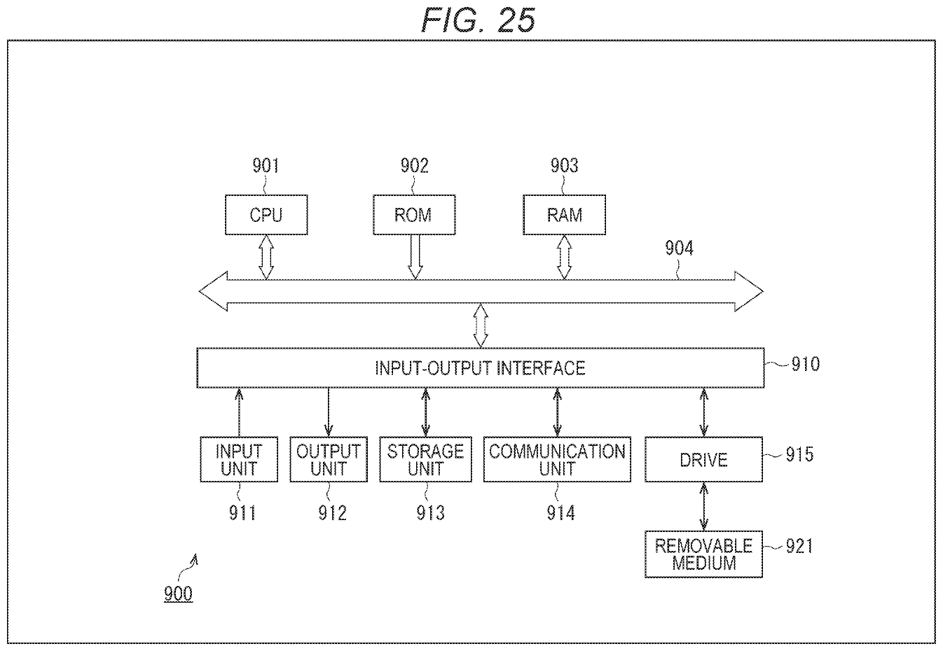

FIG. 25 is a block diagram illustrating a configuration example of hardware of a computer that executes the above-described series of processes by a program.

In a computer 900 illustrated in FIG. 25, a central processing unit (CPU) 901, a read only memory (ROM) 902, and a random access memory (RAM) 903 are mutually connected via a bus 904.

An input-output interface 910 is also connected to the bus 904. An input unit 911, an output unit 912, a storage unit 913, a communication unit 914, and a drive 915 are connected to the input-output interface 910.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a nonvolatile memory, and the like. The communication unit 914 includes, for example, a network interface. The drive 915 drives a removable medium 921 such as a magnetic disk, an optical disk, a magneto-optical disk, or a semiconductor memory.

In the computer configured as described above, the CPU 901 loads, for example, a program stored in the storage unit 913 into the RAM 903 via the input-output interface 910 and the bus 904 and executes the program, so as to perform the above-described series of processes. The RAM 903 also appropriately stores data and the like necessary for the CPU 901 to execute various processes.

The program executed by the computer can be applied by being recorded in the removable medium 921 as a package medium or the like, for example. In this case, the program can be installed in the storage unit 913 via the input-output interface 910 by attaching the removable medium 921 to the drive 915.

Furthermore, this program can be provided via a wired or wireless transmission medium such as a local area network, the Internet, or digital satellite broadcasting. In this case, the program can be received by the communication unit 914 and installed in the storage unit 913.

In addition, this program can be installed in the ROM 902 or the storage unit 913 in advance.

<Applicable Target of Present Technology>

The present technology can be applied to an arbitrary configuration. For example, the present technology can be applied to various electronic devices such as a transmitter and a receiver (for example, a television receiver and a mobile phone) in satellite broadcasting, cable broadcasting such as cable TV, distribution on the Internet, and distribution to a terminal by cellular communication, or the like, or a device (for example, a hard disk recorder and a camera) that records an image on a medium such as an optical disk, a magnetic disk, and a flash memory, or reproduces an image from the storage medium.

Furthermore, for example, the present technology can also be implemented as a configuration of a part of the device, such as a processor (for example, a video processor) as a system large scale integration (LSI) or the like, a module (for example, a video module) using a plurality of processors or the like, a unit (for example, a video unit) using a plurality of modules or the like, or a set (for example, a video set) obtained by further adding other functions to a unit.

Furthermore, for example, the present technology can also be applied to a network system including a plurality of devices. For example, the present technology may be implemented as cloud computing shared and processed in cooperation by a plurality of devices via a network. For example, the present technology may be implemented in a cloud service that provides a service related to an image (moving image) to any terminal such as a computer, an audio visual (AV) device, a portable information processing terminal, or an Internet of Things (IoT) device.

Note that in the present description, the system means a set of a plurality of components (devices, modules (parts), and the like), and it does not matter whether or not all the components are in the same housing. Therefore, a plurality of devices housed in separate housings and connected via a network, and one device in which a plurality of modules is housed in one housing are all systems.

<Field and Application to which Present Technology is Applicable>

Note that the system, device, processing unit, and the like to which the present technology is applied can be used in any fields, for example, traffic, medical care, crime prevention, agriculture, livestock industry, mining, beauty, factory, household appliance, weather, nature monitoring, and the like. Furthermore, its use is arbitrary.

<Others>

The embodiments of the present technology are not limited to the above-described embodiments, and various modifications are possible without departing from the gist of the present technology.

For example, a configuration described as one device (or processing unit) may be divided and configured as a plurality of devices (or processing units). Conversely, configurations described above as a plurality of devices (or processing units) may be combined and configured as one device (or processing unit). Furthermore, a configuration other than those described above may of course be added to the configuration of each device (or each processing unit). Moreover, if the configuration and operation of the entire system are substantially the same, a part of the configuration of a certain device (or processing unit) may be included in the configuration of another device (or another processing unit).

Furthermore, for example, the above-described program may be executed in any device. In that case, it is sufficient if the device has necessary functions (functional blocks and the like) and can acquire necessary information.

Furthermore, for example, each step of one flowchart may be executed by one device, or may be shared and executed by a plurality of devices. Moreover, in a case where a plurality of processes is included in one step, the plurality of processes may be executed by one device, or may be shared and executed by a plurality of devices. In other words, a plurality of processes included in one step can be executed as processes of a plurality of steps. Conversely, a process described as a plurality of steps can be collectively executed as one step.

Furthermore, for example, in the program executed by the computer, processes in steps for describing the program may be executed in time series in the order described in the present description, or may be executed in parallel or individually at necessary timing such as when a call is made. That is, as long as no contradiction occurs, the processes in the respective steps may be executed in an order different from the above-described orders. Moreover, the processes in steps for describing this program may be executed in parallel with processes in another program, or may be executed in combination with processes in another program.

Furthermore, for example, a plurality of technologies related to the present technology can be implemented independently as a single body as long as there is no contradiction. Of course, any plurality of the present technologies can also be used and implemented in combination. For example, part or all of the present technologies described in any of the embodiments can be implemented in combination with part or all of the present technologies described in other embodiments. Furthermore, part or all of any of the above-described present technologies can be implemented by using together with another technology that is not described above.

Note that the present technology can have configurations as follows.

(1) A signal processing device, including:
a plurality of processing units that performs respective signal processes on an input signal in series;
a parameter supply unit that supplies a parameter used for the signal processes to the plurality of processing units; and
a control unit that controls an execution timing of the signal process by each of the plurality of processing units and a supply timing of the parameter by the parameter supply unit on the basis of a synchronization signal in such a manner that pipeline processing is performed on the input signal.

(2) The signal processing device according to (1), in which
the control unit
   supplies START, which is a control signal giving an instruction to start the signal process, to the plurality of processing units, and
   supplies VLATCH, which is a control signal giving an instruction to switch the parameter to be supplied, to the parameter supply unit.

(3) The signal processing device according to (2), in which
the control unit supplies the START to the plurality of processing units via signal lines independent of each other.

(4) The signal processing device according to (3), in which
the control unit acquires BUSY, which is a control signal indicating that an operation is being performed, and DONE, which is a control signal indicating that the operation is completed, from the plurality of processing units.

(5) The signal processing device according to any one of (1) to (4), in which
the parameter supply unit further supplies INIT, which is a control signal giving an instruction on initialization, to the plurality of processing units.

(6) The signal processing device according to (5), in which
the parameter supply unit supplies the INIT to the plurality of processing units via signal lines independent of each other.

(7) The signal processing device according to (6), in which
the parameter supply unit further supplies the INIT to the control unit.

(8) The signal processing device according to (7), in which
the parameter supply unit skips initialization of the parameter supply unit itself even if the parameter supply unit supplies the INIT to the plurality of processing units and the control unit.

(9) The signal processing device according to any one of (1) to (8), in which
the parameter supply unit supplies the parameter to the plurality of processing units via a queue.

(10) The signal processing device according to (1), in which
the parameter supply unit
   includes a selection unit that selects the parameter to be supplied to the processing unit from among a plurality of the parameters, and
   supplies the parameter selected by the selection unit to the processing unit.

(11) The signal processing device according to (10), in which
the control unit supplies RBSEL, which is a control signal controlling selection of the parameter, to the selection unit.

(12) The signal processing device according to any one of (1) to (11), in which
the parameter supply unit supplies a control signal controlling an operation mode to a normal mode or a bypass mode to the plurality of processing units.

(13) The signal processing device according to (12), in which
the control unit skips supply of START, which is a control signal giving an instruction to start the signal process, to the processing unit in which the operation mode is set to the bypass mode by the parameter supply unit.

(14) The signal processing device according to any one of (1) to (13), in which
the control unit
   supplies START, which is a control signal giving an instruction to start the signal process, to the plurality of processing units, and
   supplies VLATCH, which is a control signal giving an instruction to switch the parameter to be supplied, to the parameter supply unit, and
the parameter supply unit
   supplies INIT, which is a control signal giving an instruction on initialization, to the plurality of processing units,
   supplies the parameter selected from among a plurality of parameters by a selection unit to the plurality of processing units via a queue, and
   supplies a control signal controlling an operation mode to a normal mode or a bypass mode to the plurality of processing units.

(15) The signal processing device according to any one of (1) to (14), in which
the control unit
   supplies START, which is a control signal giving an instruction to start the signal process, to the plurality of processing units, and
   supplies VLATCH, which is a control signal giving an instruction to switch the parameter to be supplied, to the parameter supply unit, and
the parameter supply unit
   supplies INIT, which is a control signal giving an instruction on initialization, to the plurality of processing units, and
   supplies the parameter selected from among a plurality of parameters by a selection unit to the plurality of processing units via a queue.

(16) The signal processing device according to any one of (1) to (15), in which
the control unit
   supplies START, which is a control signal giving an instruction to start the signal process, to the plurality of processing units, and
   supplies VLATCH, which is a control signal giving an instruction to switch the parameter to be supplied, to the parameter supply unit, and
the parameter supply unit
   supplies INIT, which is a control signal giving an instruction on initialization, to the plurality of processing units,
   supplies the parameter selected from among a plurality of parameters by a selection unit to the plurality of processing units, and
   supplies a control signal controlling an operation mode to a normal mode or a bypass mode to the plurality of processing units.

(17) The signal processing device according to any one of (1) to (16), in which
the control unit
   supplies START, which is a control signal giving an instruction to start the signal process, to the plurality of processing units, and
   supplies VLATCH, which is a control signal giving an instruction to switch the parameter to be supplied, to the parameter supply unit, and
the parameter supply unit
   supplies INIT, which is a control signal giving an instruction on initialization, to the plurality of processing units, and
   supplies the parameter selected from among a plurality of parameters by a selection unit to the plurality of processing units.

(18) The signal processing device according to any one of (1) to (17), in which
the control unit
   supplies START, which is a control signal giving an instruction to start the signal process, to the plurality of processing units, and
   supplies VLATCH, which is a control signal giving an instruction to switch the parameter to be supplied, to the parameter supply unit, and
the parameter supply unit
   supplies INIT, which is a control signal giving an instruction on initialization, to the plurality of processing units,
   supplies the parameter to the plurality of processing units, and
   supplies a control signal controlling an operation mode to a normal mode or a bypass mode to the plurality of processing units.

(19) The signal processing device according to any one of (1) to (18), in which
the input signal is an output signal of a time-of-flight (ToF) sensor, and
the plurality of processing units performs signal processing on the output signal in series.

(20) The signal processing device according to (19), further including
the ToF sensor.

### REFERENCE SIGNS LIST

100 Signal processing device
101 Control module
102 Register module
111 to 118 Signal processing module
171 to 178 Queue
191 to 198 Parameter selection unit
201 and 202 Parameter supply unit
203 Selection unit
400 Signal processing device
401 Sensor module
402 Application processor
411 ToF sensor module
412 Signal processing unit
421 ToF sensor reception unit
422 ToF sensor transmission unit

1. A signal processing device comprising:
a plurality of processing units that performs respective signal processes on an input signal in series;
a parameter supply unit that supplies a parameter used for the signal processes to the plurality of processing units; and
a control unit that controls an execution timing of the signal process by each of the plurality of processing units and a supply timing of the parameter by the parameter supply unit on a basis of a synchronization signal in such a manner that pipeline processing is performed on the input signal.

2. The signal processing device according to claim 1, wherein
the control unit
supplies START, which is a control signal giving an instruction to start the signal process, to the plurality of processing units, and
supplies VLATCH, which is a control signal giving an instruction to switch the parameter to be supplied, to the parameter supply unit.

3. The signal processing device according to claim 2, wherein
the control unit supplies the START to the plurality of processing units via signal lines independent of each other.

4. The signal processing device according to claim 3, wherein
the control unit acquires BUSY, which is a control signal indicating that an operation is being performed, and DONE, which is a control signal indicating that the operation is completed, from the plurality of processing units.

5. The signal processing device according to claim 1, wherein
the parameter supply unit further supplies INIT, which is a control signal giving an instruction on initialization, to the plurality of processing units.

6. The signal processing device according to claim 5, wherein
the parameter supply unit supplies the INIT to the plurality of processing units via signal lines independent of each other.

7. The signal processing device according to claim 6, wherein
the parameter supply unit further supplies the INIT to the control unit.

8. The signal processing device according to claim 7, wherein
the parameter supply unit skips initialization of the parameter supply unit itself even if the parameter supply unit supplies the INIT to the plurality of processing units and the control unit.

9. The signal processing device according to claim 1, wherein
the parameter supply unit supplies the parameter to the plurality of processing units via a queue.

10. The signal processing device according to claim 1, wherein
the parameter supply unit
includes a selection unit that selects the parameter to be supplied to the processing unit from among a plurality of the parameters, and
supplies the parameter selected by the selection unit to the processing unit.

11. The signal processing device according to claim 10, wherein
the control unit supplies RBSEL, which is a control signal controlling selection of the parameter, to the selection unit.

12. The signal processing device according to claim 1, wherein
the parameter supply unit supplies a control signal controlling an operation mode to a normal mode or a bypass mode to the plurality of processing units.

13. The signal processing device according to claim 12, wherein
the control unit skips supply of START, which is a control signal giving an instruction to start the signal process, to the processing unit in which the operation mode is set to the bypass mode by the parameter supply unit.

14. The signal processing device according to claim 1, wherein
the control unit
supplies START, which is a control signal giving an instruction to start the signal process, to the plurality of processing units, and
supplies VLATCH, which is a control signal giving an instruction to switch the parameter to be supplied, to the parameter supply unit, and
the parameter supply unit
supplies INIT, which is a control signal giving an instruction on initialization, to the plurality of processing units,
supplies the parameter selected from among a plurality of parameters by a selection unit to the plurality of processing units via a queue, and
supplies a control signal controlling an operation mode to a normal mode or a bypass mode to the plurality of processing units.

15. The signal processing device according to claim 1, wherein
the control unit
supplies START, which is a control signal giving an instruction to start the signal process, to the plurality of processing units, and
supplies VLATCH, which is a control signal giving an instruction to switch the parameter to be supplied, to the parameter supply unit, and
the parameter supply unit
supplies INIT, which is a control signal giving an instruction on initialization, to the plurality of processing units, and
supplies the parameter selected from among a plurality of parameters by a selection unit to the plurality of processing units via a queue.

16. The signal processing device according to claim 1, wherein
the control unit
supplies START, which is a control signal giving an instruction to start the signal process, to the plurality of processing units, and
supplies VLATCH, which is a control signal giving an instruction to switch the parameter to be supplied, to the parameter supply unit, and
the parameter supply unit
supplies INIT, which is a control signal giving an instruction on initialization, to the plurality of processing units,
supplies the parameter selected from among a plurality of parameters by a selection unit to the plurality of processing units, and
supplies a control signal controlling an operation mode to a normal mode or a bypass mode to the plurality of processing units.

17. The signal processing device according to claim 1, wherein
the control unit
supplies START, which is a control signal giving an instruction to start the signal process, to the plurality of processing units, and
supplies VLATCH, which is a control signal giving an instruction to switch the parameter to be supplied, to the parameter supply unit, and
the parameter supply unit
supplies INIT, which is a control signal giving an instruction on initialization, to the plurality of processing units, and
supplies the parameter selected from among a plurality of parameters by a selection unit to the plurality of processing units.

18. The signal processing device according to claim 1, wherein
the control unit
supplies START, which is a control signal giving an instruction to start the signal process, to the plurality of processing units, and
supplies VLATCH, which is a control signal giving an instruction to switch the parameter to be supplied, to the parameter supply unit, and
the parameter supply unit
supplies INIT, which is a control signal giving an instruction on initialization, to the plurality of processing units,
supplies the parameter to the plurality of processing units, and
supplies a control signal controlling an operation mode to a normal mode or a bypass mode to the plurality of processing units.

19. The signal processing device according to claim 1, wherein
the input signal is an output signal of a time-of-flight (ToF) sensor, and
the plurality of processing units performs signal processing on the output signal in series.

20. The signal processing device according to claim 19, further comprising
the ToF sensor.
